(19) United States
(12) Patent Application Publication
(10) Pub. No.: US 2002/0078097 A1
(43) Pub. Date: Jun. 20, 2002

(54) System for automatically allocating layout and the allocation method thereof

(75) Inventors: Mu-Ann Chen, Hsinchu Hsien (TW); Jung-Yuan Hsu, Hsinchu (TW); Tsun-Yi Lee, Hsinchu (TW)

Correspondence Address: DARBY & DARBY P.C., 805 Third Avenue, New York, NY, 10022, US

(73) Assignee: Institute For Information Industries, Taipei (TW)

(21) Appl. No.: 09/837,501

(22) Filed: Apr. 18, 2001

(30) Foreign Application Priority Data
Dec. 18, 2000 (TW) 89127083

(51) Int. Cl. G06F 17/21; G06F 17/24

(52) U.S. Cl. 707/517; 707/520

(57) ABSTRACT

A system for automatically allocating a layout suitable for a web page. The system of the present invention utilizes an editing unit provided with a layout template having a plurality of display areas for inputting data and an integrating unit for integrating display areas that contain data with adjacent display areas that do not contain data. The systems can also include a data unit for providing a plurality of data to input into the display areas, a previewing unit with an integrated layout, and a memory unit for storing the integrated layout. The integration unit determines whether display areas adjacent to a selected display area contain data. If not, the display areas are merged.

### BACKGROUND OF THE INVENTION

1. Field of the Invention

The present invention relates to a method and apparatus for automatically allocating layout. In particular, it relates to a method and apparatus for automatically allocating the layout of data to be displayed on a web page.

2. Description of the Related Art

The past several years have seen an explosive growth of the World Wide Web (hereinafter “the Web”). The Web is built around a network of server computers, which exchange requests and data with each other using the hypertext transfer protocol (hereinafter “http”). Data, including images and text, is displayed on web pages designed by a web page author who specifies the layout of the page using Hypertext Markup Language (“HTML”).

Programming in HTML is time consuming. If the design of the page changes, the corresponding HTML must be rewritten, which is an exacting process. Although many new editors provide users with “What You See Is What You Get” capability, the layout of data must be performed manually.

### SUMMARY OF THE INVENTION

Accordingly, it is an object of the present invention to provide a system for automatically allocating layout. The system of the present invention comprises an editing unit and an integrating unit. The editing unit provides a layout template having a plurality of display areas for inputting data. The integrating unit integrates display areas that contain data with adjacent display areas that do not contain data.

In a preferred embodiment, the system of the present invention also includes a data unit, a previewing unit and a memory unit. The data unit provides a plurality of data to input into the display areas. The previewing unit provides a previewing function of the layout that had been integrated by the integrating unit. The memory unit saves the layout that has been integrated by the integrating unit.

The present invention also provides a method for automatically allocating layout. The method of the present invention comprises the steps of:

Inputting a least one data into at least one display area of a layout template with a plurality of display areas;

Selecting a first display area;

Determining whether a second display area adjacent to the first display area in the horizontal direction contains data;

Merging the first display area with the second display area if the second display area does not contain data;

Determining whether a third display area adjacent to the first display area in the vertical direction contains data; and

Merging the first display area with the third display area if the second display area does not contain data.

The preferred embodiment of the present invention further comprises the steps of:

Outputting the layout template with merged display areas into a web page; and

Saving the first page in a memory unit.

Reference to the remaining portions of the specification, including the drawings and claims, will realize other features and advantages of the present invention. Further features and advantages of the present invention, as well as the system and operation of the various embodiments of the present invention, are described in detail below with respect to the accompanying drawings.

### BRIEF DESCRIPTION OF THE DRAWINGS

The present invention can be more fully understood by reading the subsequent detailed description in conjunction with the examples and references made to the accompanying drawings, wherein:

FIG. 1 is a structure diagram of system of present invention;

FIG. 2 is a schematic view of steps of present invention;

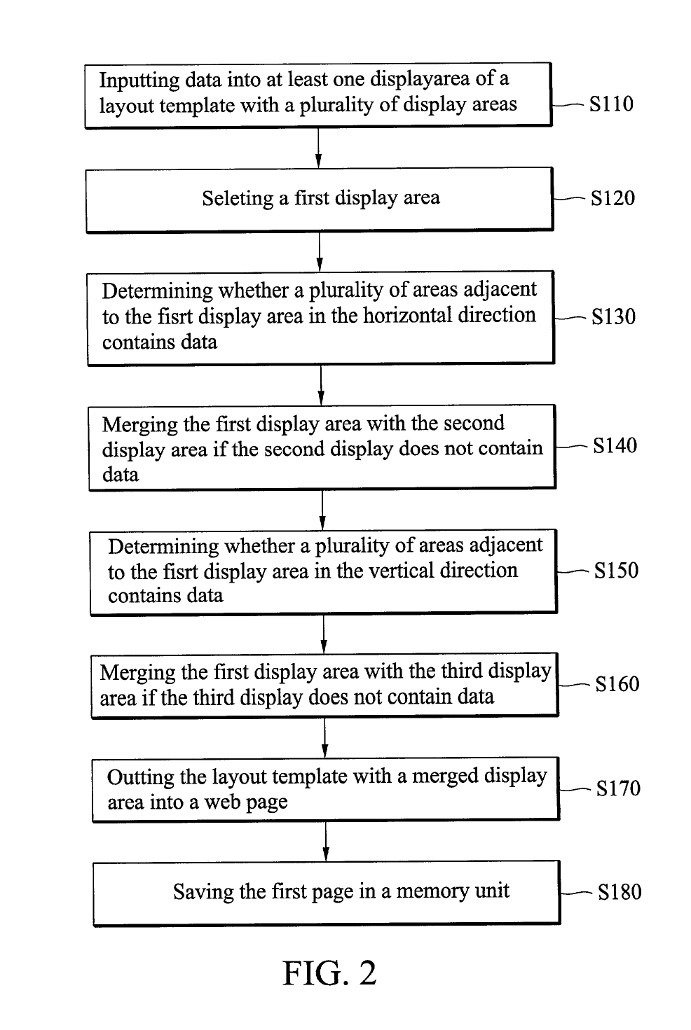

FIG. 3 is a diagram of a preferred embodiment of the present system; and

FIGS. 4a˜4c are schematic views illustrating the operation of present invention.

### DETAILED DESCRIPTION OF THE PREFERRED EMBODIMENT

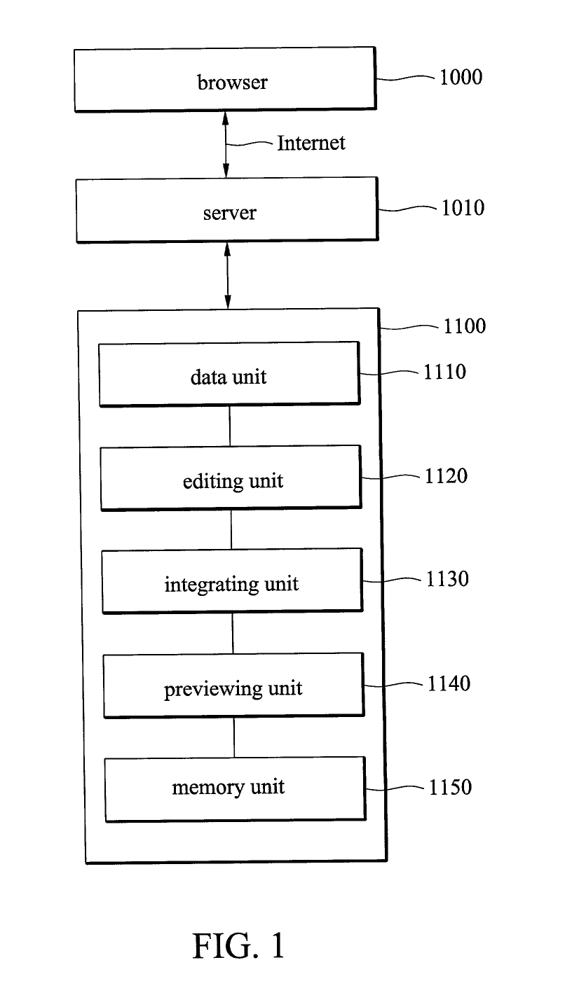

As shown in FIG. 1, a preferred embodiment of the system for automatically allocating layout of the present invention comprises a data unit 1110, a editing unit 1120, a integrating unit 1130, a previewing unit 1140, and a memory unit 1150.

The system of the present invention can be implemented on a personal computer. Alternately, the system of the present invention can be implemented on a server 1010, wherein a user 1000 can connect to server 1010 via a network such as the Internet.

In the preferred embodiment, data unit 1110 provides a plurality of data and editing unit 1120 provides a layout template having a plurality of display areas. Data to be displayed is entered into one or more display areas by user 1000. Afterwards, the integrating unit 1130 automatically integrates display areas containing data with display areas not containing data. The previewing unit 1140 allows the previewing of the integrated layout. The memory unit 1150 provides a function for saving the layout had been integrated by the integrating unit 1130.

According to the present invention, a method for automatically allocating layout comprises the step of:

S110, inputting at least one data into at least one display area of a layout template with a plurality of display areas.

S120, selecting a first display area;

S130, determining whether a second display area adjacent to the first display area in the horizontal direction first contains data;

S140, merging the first display area with the second display area if the second display area does not contain data;

S150, determining whether a third display area adjacent to the first display area in the vertical direction contains data.

S160, merging the first display area with the third display area if the second display area does not contain data.

S170, outputting the layout template with merged display areas into a web page; and

S180, saving the first page in a memory unit.

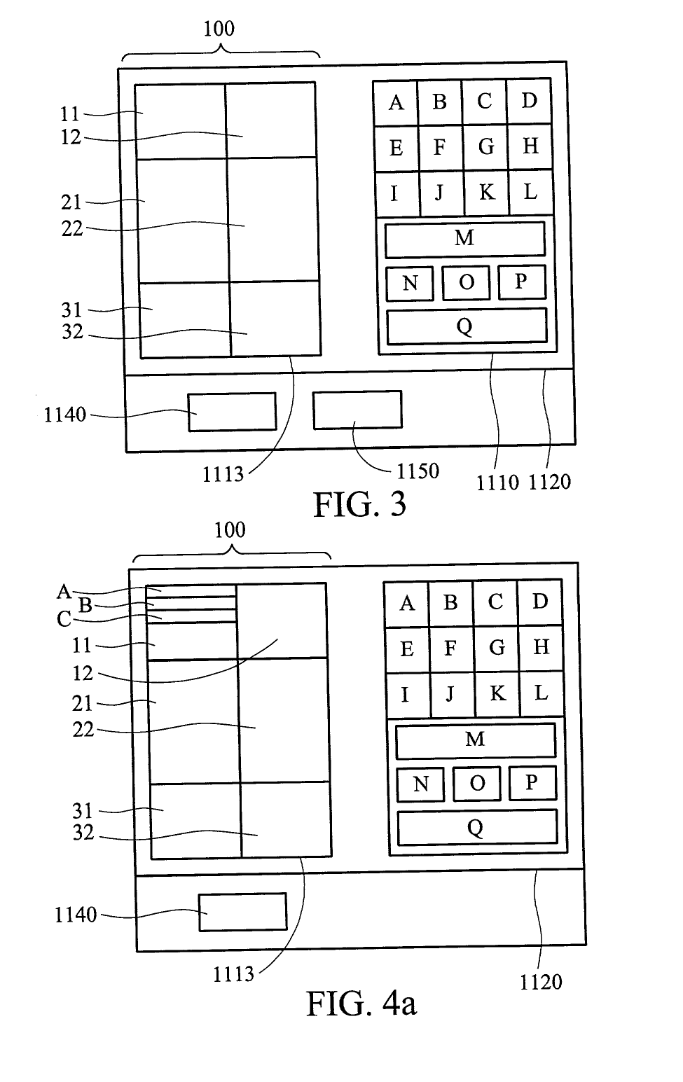

FIG. 3 illustrates editing unit 1120 of a preferred embodiment of the system of the present invention. On the left is a layout template 1113 having six display areas 11, 12, 21, 22, 31, and 32. On the right portion is data display area of the data unit 1110 for displaying data stored therein. In this embodiment, the data is represented by blocks “A˜Q.” The data can be, for example, words, pictures, icons, fields, and/or hyperlinks. And a button of the previewing unit 1140 at the lower left corner allows for the previewing of the integrated layout template.

A browser can be used to access the system for automatically allocating the layout of the present invention via the Internet. Alternately, the system of the present invention could be implemented as a program for use on a personal computer.

The operation of the system for automatically allocating layout of the present invention will now be described. A mouse click on a display area of the editing unit 1120 selects and marks this area as active. Then, data desired to be displayed is clicked in the data unit 1110 (for example, an image or an item of text). Clicked data is displayed in the active display area 11 at the left. Data can be removed from a display area by clicking on the data representation in the display area. A resulting web page after operation of the integrating unit is obtained by clicking the button of the previewing unit 1140. A web page can be saved by memory unit 1150. The resulting web page can posted on the network and viewed by other browsers.

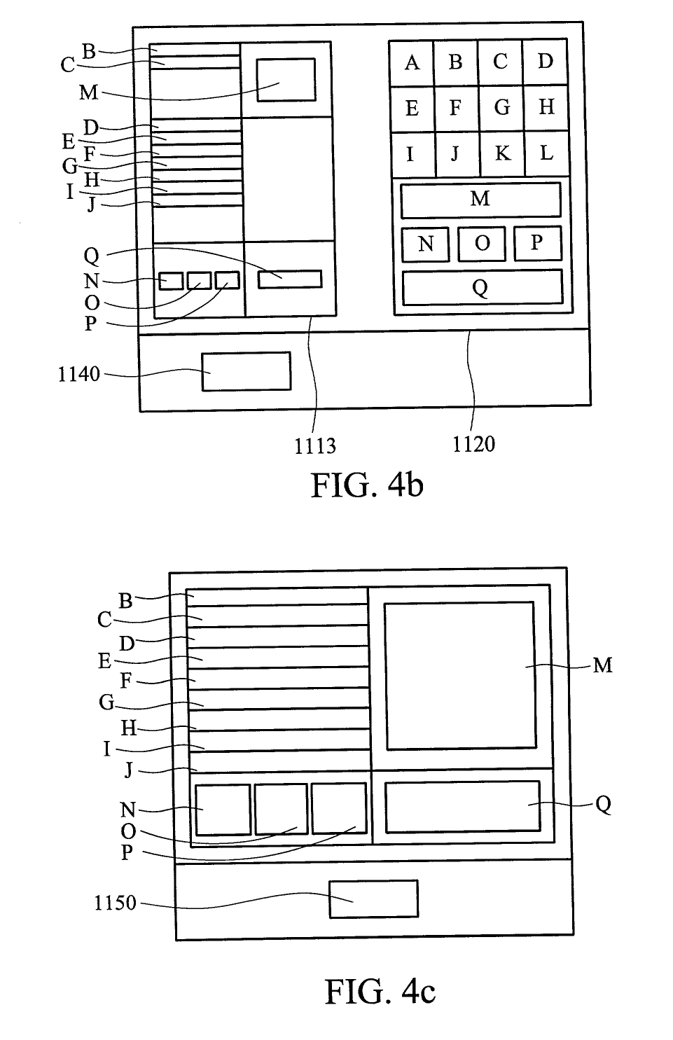

FIGS. 4A-4C illustrate an example of the operation of the present invention. In FIG. 4A, a click on the display area 11 activates and marks the area. Then a click on text data “A”, “B”, and “C”, respectively cause data A, B and C from the data unit 1110 to be displayed in display area 11.

In this example, data A from in display area 11 is clicked again, leaving only data B and C in display area 11 in FIG. 4B.

In FIG. 4B, a click on the display area 21 activates and marks the area. Then, a click on text data “D”, “E”, “F”, “G”, “H”, “I”, “J”, “K” enters this data into display area 21. Using the same technique, image data “N”, “O”, and “P”, is entered into display area 31, while business icon “M” is entered into display area 12 and hyperlink data “Q” is entered into display area 32 and then click the at the right.

In this example, data is input into five display areas “11”,“12”, “21”, “22”, “31”, “32”. Display area “22” is empty.

By clicking the button of previewing unit 1140, the steps display areas are integrated, and a resulting page is generated, as shown in FIG. 4C. The resulting page can be saved by clicking the button of the memory unit 1150.

The operation of the automatic integration unit of the present invention applied display layout shown in FIG. 4B is described as follows.

First, the integration unit selects a first display area. In this example, the first area selected is the first row and the first column of the layout template 100, namely display area 11. Then the integration unit determines whether a second display area adjacent to the first in a horizontal direction contains data. In this example, this is display area 12, which does contain data. Therefore, the display areas are not merged. Then the integration unit determines whether a third display area adjacent to the first in a vertical direction contains data. In this example, this is display area 21, which does contain data. Therefore, the display areas are not merged.

In this example, the integration unit then selects the display area in the first row and second column, namely display area 12, to be the next first display area. Then the integration unit determines whether a second display area adjacent to the first in a horizontal direction contains data. In this example, this is display area 11, which does contain data. Therefore, the display areas are not merged. Then the integration unit determines whether a third display area adjacent to the first in a vertical direction contains data. In this example, this is display area 22, which does not contain data. Therefore, display area 12 and display area 22 are merged. The resulting merged area is larger in size. In one implementation of this invention, the representation of data displayed in a display takes a size relative to the display area. Therefore, when two display areas are merged, the data contained therein is increased in side. In this example, image data M becomes larger in size to fill the merged display areas.

The integration unit then moves to the next row and selects display area 21 to be the first display area. Since display area 22 has been merged with display area 12, this area now contains data M. Display area 31 also contains data. Thus, the integration unit selects display area 22 to be the first display area. The same process is carried out, leading the integration unit to select display areas from the third row.

It is understood that the integration unit can select first display areas according to a left to right pattern or a right to left pattern, an up to down pattern or a down to up pattern, or any other pattern, including randomly selecting first display areas. Furthermore, it is understood that the selection of second display areas in a horizontal direction may be made to the left or the right of the first display area or both, and the selection of third display areas in a vertical direction may be made to the above or the below of the first display area or both. The operation of the integration unit can be implemented, for example, by a computer program.

FIG. 4C shows the resulting output page. The output page has a larger area since data display portion 200 need not be shown. Furthermore, display areas 12 and 22 have been merged. The page may now be saved in memory unit 1150.

The system and method for automatically allocating layout of the present invention quickly disposes data in an attractive layout without the need to rewrite HTML program or manually resize the display areas.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for automatically allocating layout, comprising:
an editing unit having a layout template comprising a plurality of display areas, wherein data is inputted into a least one display area; and
an integrating unit for automatically merging display areas that contain data with adjacent display areas that do not contain data.

2. The system for automatically allocating layout as claimed in claim 1, wherein the integrating unit selects a first display area of the plurality of display areas, and determines whether a second display area adjacent to the first display area in the horizontal direction contains data, and merges the first and second display areas if the second display area does not contain data, and determines whether a third display area adjacent to the first display area in the vertical direction contains data, and merges the first and third display areas if the third display area does not contain data.

3. The system for automatically allocating layout as claimed in claim 1, further comprising a data unit for storing data to be inputted into the display areas.

4. The system for automatically allocating layout as claimed in claim 1, further comprising a previewing unit for providing a preview of a layout after automatic merging by the integrating unit.

5. The system for automatically allocating layout as claimed in claim 1, further comprising a memory unit for saving a layout that is automatically merged by the integrating unit.

6. The system for automatically allocating layout as claimed in claim 1, wherein the plurality of display areas in the layout template comprise a grid with at least one row or one column.

7. The system for automatically allocating layout as claimed in claim 1, wherein the layout template is a web page.

8. A method for automatically allocating layout, comprising:
inputting a least one piece of data into at least one display area of layout template with a plurality of display areas;
selecting a first display area;
determining whether a second display area adjacent to the first display area in a first direction contains data; and
merging the first display area with the second display area if the second display area does not contain data.

9. The method of claim 8, further comprising the step of:
outputting the layout template with merged display areas into a web page.

10. The method of claim 9, further comprising the step of:
saving the web page in a memory unit.

11. The method of claim 8, wherein the first direction is horizontal.

12. The method of claim 8, wherein the first direction is vertical.

13. The method as claimed in claim 8, further comprising the steps of:
determining whether a third display area adjacent to the first display area in a second direction contains data;
merging the first display area with the third display area if the third display area does not contain data;

14. The method of claim 13, wherein the second direction is horizontal.

15. The method of claim 13, wherein the second direction is vertical.
